(19) United States
(12) Patent Application Publication
(10) Pub. No.: US 2007/0072040 A1
(43) Pub. Date: Mar. 29, 2007

(54) Fuel cell

(75) Inventors: Sebastien Kouassi, Joue Les Tours (FR); Mathieu Roy, Joue Les Tours (FR)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics S.A., Montrouge (FR)

(21) Appl. No.: 11/528,818

(22) Filed: Sep. 28, 2006

(30) Foreign Application Priority Data
Sep. 29, 2005 (FR) 05/52944

(51) Int. Cl. H01M 2/02; H01M 8/04; H01M 4/86

(52) U.S. Cl. 429/34; 429/26; 429/42

(57) ABSTRACT

A fuel battery cell covered with a hydrophilic polymer layer.

### BACKGROUND OF THE INVENTION

1. Field of the Invention

The present invention relates to a fuel cell.

2. Discussion of the Related Art

FIG. 1 shows an example of a fuel cell formed by microelectronic techniques. The cell is formed on a silicon wafer 1 coated with a first thin insulating layer 2 and with a second thicker insulating layer 3. An opening is formed in a portion of insulating layer 3. In this opening are successively deposited a support 4, a catalyst layer 5, an electrolyte 6, and a second catalyst layer 7. An electrode 10, placed on first insulating layer 2, enables taking a contact on the lower battery cell surface, on support 4. An opening 11 of second insulating layer 3 enables accessing to electrode 10. An upper electrode 12 enables taking a contact on upper catalyst layer 7. Electrodes 10 and 12 are provided with openings, and channels 13 are formed in silicon wafer 1 opposite to the openings in the lower surface metallization. Lower electrode 10 and upper electrode 12 respectively form an anode collector and a cathode collector.

Electrolyte 6 for example is a polymer acid such as Nafion in solid form and the catalyst layers for example are carbon- and platinum-based layers. This is an example of embodiment only. Various types of fuel cells that can be formed as illustrated in FIG. 1 are known in the art.

To operate the fuel cell, hydrogen is injected along arrow H₂ on the lower surface side and air (carrying oxygen) is injected on the upper surface side. The hydrogen is “decomposed” at the level of catalyst layer 5 to form on the one hand H+protons which direct towards electrolyte 6 and on the other hand electrons which direct, by the outside of the cell, towards anode collector 10. The H+protons cross electrolyte 6 to reach catalyst layer 7 where they recombine with oxygen and electrons coming from the outside of the cell via the cathode collector. In a known fashion, with such a structure, a positive voltage is obtained on cathode collector 12 (on the oxygen side) and a negative voltage is obtained on anode collector 10 (on the hydrogen side).

A disadvantage of this type of fuel cell is that electrolyte 6 tends to desiccate along its use and the cell performances decrease.

### SUMMARY OF THE INVENTION

An object of the present invention is to provide a fuel cell comprising an electrolyte which does not desiccate.

An object of the present invention is to provide such a fuel cell of simple structure.

To achieve these and other objects, the present invention provides a fuel battery cell covered with a hydrophilic polymer layer.

According to an embodiment of the above-mentioned fuel battery cell, the hydrophilic polymer layer is placed close to a region of the cell where water is generated.

According to an embodiment of the above-described fuel battery cell, the hydrophilic polymer layer is porous or exhibits openings to enable passing of a gas such as oxygen.

According to an embodiment of the above-described fuel battery cell, a layer of a hydrophobic material covers the hydrophilic polymer layer.

According to an embodiment of the above-described fuel battery cell, the hydrophobic material layer is porous for this gas or exhibits at least one opening to enable passing of a gas such as oxygen.

According to an embodiment of the above-described fuel battery cell, the hydrophilic polymer layer is thermally conductive.

According to an embodiment of the above-described fuel battery cell, the hydrophilic polymer layer contains carbon nanotubes.

According to an embodiment of the above-described fuel battery cell, the layer of a hydrophobic material is thermally conductive.

According to an embodiment of the above-described fuel battery cell, the layer of a hydrophobic material is formed of carbon nanotubes.

According to an embodiment of the above-described fuel battery cell, the cell comprises an electrolyte placed between first and second catalyst layers placed between first and second catalyst layers respectively connected to an anode collector and to a cathode collector, hydrogen being brought to the rear surface of the cell at the level of the first catalyst layer, and oxygen being brought to the front surface of the cell at the level of the second catalyst layer, said hydrophilic polymer layer being placed at the front surface above the second catalyst layer and passing oxygen.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 is a cross-section view of a known fuel battery cell;

FIG. 2 is a cross-section view of a fuel battery cell according to the present invention; and

FIG. 3 is a cross-section view of a fuel battery cell according to an alternative embodiment of the cell shown in FIG. 2.

### DETAILED DESCRIPTION

For clarity, the same elements have been designated with the same reference numerals in the different drawings and, further, as usual in the representation of integrated circuits, the various drawings are out of scale.

To avoid desiccation of a fuel battery cell, the present invention provides retaining the water naturally generated by the cell. Indeed, when the H+protons recombine with oxygen and electrons coming through the cathode collector, water forms at the level of upper catalyst layer 7. To avoid that this water evaporates, the present invention provides placing a hydrophilic polymer layer close to upper catalyst layer 7. This hydrophilic polymer layer enables maintaining a damp environment in the cell, and especially at the level of electrolyte 6.

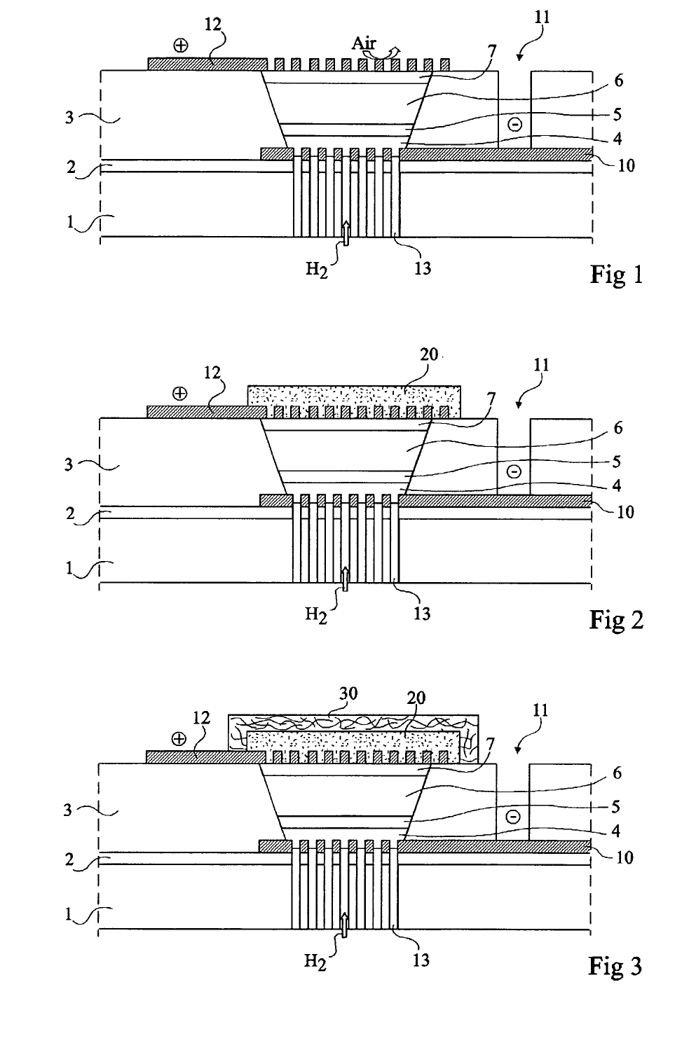

FIG. 2 is a cross-section view of a fuel cell which comprises all the elements of the cell shown in FIG. 1. According to an aspect of the present invention, a hydrophilic polymer layer 20 is placed above upper catalyst layer 7. Hydrophilic polymer layer 20 covers the portion of upper electrode 12 located above upper catalyst layer 7 as well as the portions of insulating layer 3 located close to catalyst layer 7. A portion of upper electrode 12 located above second insulating layer 3 is exposed to leave its access free. Similarly, opening 11 is left free to enable access to lower electrode 10.

Further, to enable passing of air, and especially of oxygen, towards upper catalyst 7, hydrophilic polymer layer 20 preferably is porous. An example of a porous hydrophilic polymer layer is for example formed of agglomerated polyethylene functionalized by hydroxyl groups. In the case where the polymer layer is not porous, through openings are formed therein to allow an oxygen flow.

Further, another way to limit the evaporation of the water generated by the battery cell is to “cool down” the cell, since the evaporation increases as the cell temperature increases. To ease the thermal dissipation of the heat generated by the fuel battery cell, a thermally-conductive hydrophilic polymer layer is thus preferably selected.

For this purpose, a hydrophilic polymer layer containing carbon nanotubes may be used. Carbon nanotubes being very good heat conductors, the presence of a small quantity thereof provides a very good heat dissipation.

FIG. 3 is a cross-section view of a fuel battery cell comprising the same elements as those of the cell shown in FIG. 2. This cell further comprises a layer of a hydrophobic material 30 covering hydrophilic polymer layer 20. Hydrophobic layer 30 enables further limiting the evaporation of the water generated by the fuel cell.

The hydrophobic material layer preferably is formed of a porous material, letting through oxygen. In the opposite case, an opening of hydrophobic polymer layer 30 should be provided above upper catalyst layer 7 to let the oxygen necessary to the fuel battery cell operation flow.

An example of a porous hydrophobic layer letting oxygen flow is a layer formed of carbon nanotubes. Such a layer further provides a very good thermal dissipation of the heat generated by the fuel battery cell.

Of course, the present invention is likely to have various, alterations, improvements, and modifications which will readily occur to those skilled in the art. In particular, the previously-described drawings show a single fuel battery cell. In practice, on the same wafer 1, a large number of cells that may be assembled in series/parallel according to the desired use may be formed.

Further, the present invention applies to various types of fuel cells for which it is useful to retain the water that they generate.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A fuel battery cell covered with a hydrophilic polymer layer.

2. The fuel battery cell of claim 1, generating water when used, the hydrophilic polymer layer being placed close to a region of the cell where water is generated.

3. The fuel battery cell of claim 1, wherein the hydrophilic polymer layer is porous or has openings to enable passing of a gas such as oxygen.

4. The fuel battery cell of claim 1, wherein a layer of a hydrophobic material covers the hydrophilic polymer layer.

5. The fuel battery cell of claim 3, wherein the hydrophobic material layer is porous for this gas or exhibits at least one opening to enable passing of a gas such as oxygen.

6. The fuel battery cell of claim 1, wherein the hydrophilic polymer layer is thermally conductive.

7. The fuel battery cell of claim 6, wherein the hydrophilic polymer layer Contains carbon nanotubes.

8. The fuel battery cell of claim 4, wherein the layer of a hydrophobic material is thermally conductive.

9. The fuel battery cell of claim 8, wherein the layer of a hydrophobic material is formed of carbon nanotubes.

10. The fuel battery cell of claim 1, comprising an electrolyte placed between first and second catalyst layers placed between first and second catalyst layers respectively connected to an anode collector and to a cathode collector, hydrogen being brought to the rear surface of the cell at the level of the first catalyst layer, and oxygen being brought to the front surface of the cell at the level of the second catalyst layer, said hydrophilic polymer layer being placed at the front surface above the second catalyst layer and passing oxygen.
